(19) United States
(12) Patent Application Publication
(10) Pub. No.: US 2016/0335929 A1
(43) Pub. Date: Nov. 17, 2016

(54) ELECTRONIC TRAFFIC SIGN WITH ATTACHMENTS

(71) Applicants: HERSHY MEISELS, Brooklyn, NY (US); Moshe Meisels, Brooklyn, NY (US)

(72) Inventors: HERSHY MEISELS, Brooklyn, NY (US); Moshe Meisels, Brooklyn, NY (US)

(73) Assignee: BSDM & M, INC., BROOKLYN, NY (US)

(21) Appl. No.: 14/708,338

(22) Filed: May 11, 2015

(51) Int. Cl. G09F 7/00; G07B 1/00; G07B 15/00; H04N 7/18; H04B 1/3883; G08G 1/09; G09F 27/00; G06Q 20/10; G08B 25/12

(52) U.S. Cl. CPC G09F 7/00; G06Q 20/1085; G07B 1/00; G07B 15/00; G08B 25/12; H04B 1/3883; G08G 1/09; G09F 27/00; G09F 27/004; G09F 27/005; G09F 27/007; H04N 7/183; H04W 84/12

(57) ABSTRACT

The present invention discloses an electronic traffic device, including a tower or pole having mounted thereon a plurality of devices, including at least one audio speaker connected to an electronic source of information in order to provide public announcements to persons in the area of the speaker. The electronic traffic device also includes at least one security camera electronically connected to a local police station in order to provide to police a camera surveillance of events occurring in the area of the security camera; electronic signs to provide weather information, traffic information, and parking information; a public phone that can be used by the public to call for assistance in an emergency; an alarm button connected to the local police and fire department, so that a person in the area can press the alarm and send a signal to the local police or fire department; a street lamp for providing light to the area which is connected to a power source on the traffic device, which may include either a battery pack or solar panel for providing power to the electronic devices on the tower; and a charging device for cell phones and other devices for the public in the area to use.

### FIELD OF THE INVENTION

The present invention relates to an improved electronic traffic sign that includes a pole or tower having mounted thereon audio speakers for public announcements, a security camera, electronic signs providing weather information, traffic information, and parking availability, a street lamp, a solar panel for providing power to the electronic traffic sign, a public phone for the public to use in an emergency, an alarm to call police or signal a fire, a cell phone charger for the public to use, and other safety and convenience features.

### BACKGROUND OF THE INVENTION

The prior art discloses electronic signs for traffic information, solar panels on poles, an alarm button, and a street lamp. However, these limited features are not sufficient for crowded cities with many cars and pedestrians who need more services and facilities to improve safety features; for providing information about weather, traffic, and parking; as well as other services; and for providing convenience features to the public.

The present invention solves these problems.

### DESCRIPTION OF THE PRIOR ART

The following prior art patents and patent applications disclose Digital Roadway Signs, which may include ads, parking messages, cameras, fire/police alarms, and/or solar panels to provide a power source:

1) Abandoned U.S. Patent Publication No. 2012/0113254 entitled “Miniature Billboard Advertisements Having Security Features” was published on May 10, 2012, and discloses street-level advertising billboards. The billboards may be located on stoplights, walk/don't walk signs, or the like. The billboards may include an electronic display panel for displaying an advertisement, a network interface for wirelessly sending collected data to and receiving advertisement display data from the advertisement system, and a sensor for collecting external data. The billboards may include one or more additional sensors for sensing security threats.

Referring to FIG. 3, there is shown a perspective view of a street-level billboard 10-4 attached to existing wires 52 that power a stop light 54. The wires 52 may run between poles 56. Power for the billboard 10-4 may be gained from the wires 52, or, as discussed below, a solar panel (FIG. 4).

The billboard 10 may include one or more external sensors 40 to collect data. The sensor may collect data such as number of people or animals (such as pets) within a certain distance, such as a typical viewing distance, of the billboard, the types and/or number of vehicles passing under the billboard, the time of day, the weather, and the like. One or more of the sensors 40 may include a camera for taking photographs around the location of the billboard. The photographs may be stored in the memory 36 and sent from the billboard via the network interface 34. Photographs may be taken, for example, during playback of an advertisement as a research tool to determine whether the advertisement captures the attention of viewers and what demographic of viewers may stop to view the advertisement.

The billboard 10 may appear in a variety of locations. The billboard 10 may, especially when fitted with a security sensor, be deployed at bridge/tunnel entrances and/or exits, at exit signs, entrances to arenas and stadiums, mass transit stations, airports, airline jetways, airplane entrances, airline cargo/baggage streams, ship terminals, courts, hospitals, shopping centers, parking garages, schools, and the like. The billboard 10 may appear to be a digital advertisement type of billboard, thereby not alerting suspects that they are being monitored and/or scanned for potential security risks. For example, as shown in FIG. 9, the billboard 10 may be disposed in a corridor, such as a corridor at an airport or train terminal. The billboard, disposed in such a corridor, may have sensors 40 that detect items in front and/or to the sides and/or below the billboard 10.

The sensors 40 may include one or more cameras for taking photographs of either advertisement traffic or persons of interest for which a safety sensor has detected a potential threat. The camera may be able to zoom on a particular subject of interest. For safety threats, the image taken by the camera may be sent to the appropriate authorities via the network interface 34. The camera may send or stream data to a face recognition program in order to detect persons of interest from the photo and/or video data stream. For example, the face recognition program may be used to detect potential terrorists, wanted persons, or other security threats. The face recognition program may also be used to search for people missing or abducted, for example, upon the issuance of an amber or silver alert.

The billboard 10 may include a remote management station 48 for remotely controlling the advertisements displayed on the billboard 10, for receiving data collected by the sensor 40, and for interfacing with the network interface 34. The remote management station 48 may communicate via conventional wireless protocols with the billboard 10, for example, via network interface 34.

2) U.S. Pat. No. 8,675,909 entitled “Traffic Signal Connected Digital Electronic Display and Method of Controlling the Same” was issued on Mar. 18, 2014, and discloses a digital electronic display connected to a traffic signal and a method of controlling the digital electronic display. The digital electronic display includes a communication unit configured to receive content including content segments and metadata, a display screen, and a processor. The processor is configured to monitor the traffic signal to determine when, and the duration during which, a red light and a green light of the traffic signal is illuminated, present a content segment on the display screen corresponding to the red light based on the metadata and substantially for the entire duration when the red light is illuminated, and control the display screen to operate in a low-power state substantially for the entire duration when the green light is illuminated.

Referring to FIG. 6, in some embodiments, the digital electronic display 200 replaces the signal stack 120 of the traffic signal 100. That is, a red light, a yellow light, a green light, a left arrow, a right arrow, a straight arrow, and a timer display may be shown as images on the display screen 260, such as by dedicating portions (or even a single portion) of the display screen 260 for such display. Embodiments of how images may appear on the display screen are shown in FIGS. 6A, 6B, and 6C. In FIG. 6A, the sign 200 displays weather information. In FIG. 6B, the sign 200 displays directions to a nearby hotel using an arrow 610. In FIG. 6C, a situation is shown where the right arrow 620 is illuminated, and at the same time, an advertisement appears on the display screen 200 related to the “Super Pizza Kitchen” restaurant which is 355 m in the rightward direction. The digital electronic display 200 may be connected to the traffic signal controller 130, and receive control signals therefrom for illumination control of these portions of the display screen 260. Alternatively, the processor 270 may determine in real time the state of the traffic signal 100 by analyzing the image signal output by the camera 240 as described above and correspondingly control the illumination of these portions of the display screen 260.

In some embodiments, the digital electronic display 200 further comprises a renewable energy unit 290. The renewable energy unit 290 may include a solar panel 292, a micro wind turbine 294, and a rechargeable battery 296 that is charged by the solar panel 292 and/or the micro wind turbine 294. The rechargeable battery 296 of the renewable energy unit 290 provides power to all elements of the digital electronic display 200. Hence, the digital electronic display 200 does not need to be connected to an external power source, such as an AC power supply to which the traffic signal 100 is also connected, as described above. Ease of installation is achieved with the provision of the renewable energy unit 290. In this and the other configurations that allow for simplified installation, the goal of realizing a fully autonomous unit is also realized.

3) Abandoned U.S. Patent Publication No. 2012/0095845 entitled “Method and System for Distributed Marketing Displays on Highway Signage” was published on Apr. 19, 2012 and discloses marketing communications being delivered by advertising displays affixed to or surrounding highway signage, e.g., bridges, tunnels, and road signs. Moreover, on digital displays, advertising messages could be changed via a wireless network.

The portion labeled 109, the graphical layer of printed images or digital display, in front of the magnetic layer comprises, in the case of digital displays, a plurality of LEDs powered by an attached solar panel. Signage with a combination of digital and print images would also have LEDs powered by attached solar panels that store electricity in lithium ion batteries. Such a power source would allow the sign to continue to operate if there was a power failure in the area. The portions labeled 107, 105 are where a holographic or digital layer would be placed on the advertising image to allow changes with position of the observer. The portion labeled 103 would be the front protective layer protecting display materials from damage caused by natural elements. On the front surface portion of 101 a CCD camera would be placed to record weather and traffic conditions or other events of interest. Moreover, CCD cameras would be useful for security video surveillance to combat highway crime and violence. In addition, CCD cameras would count and monitor vehicular traffic.

4) Abandoned U.S. Patent Publication No. 2004/0044574 entitled “Apparatus for Displaying Local Advertising to a Display Screen” was published on Mar. 4, 2004 and discloses an intelligent display device includes a display screen controlled by a microprocessor unit. The intelligent display device has sensors that feedback information from the environment to the microprocessor control for use in intelligently dynamically display advertisements. The display includes a connection to a network, which may be the Internet and further includes soft-keys for allowing passers-by to interact with the device.

It is well known in the art to advertise on billboards for passers-by to view and read the display in hope of promoting an advertisers product or service. Certain billboards may be positioned close to a highway where drivers can read the advertising information as they travel back and forth. Establishments may place a variety of advertising billboards or signs in key locations of population or traffic density where the signs may vary in size and configuration. Some advertising signs may even include lighted images or moving parts.

The intelligent advertising device 1 may be powered by solar power or means. However, any means of providing power to the intelligent advertising device 1 may be chosen with sound engineering judgment.

With reference to FIGS. 1 and 5, the intelligent advertising device 1 may include a camera 44 as previously mentioned. The camera 44 may be utilized to retain user interaction information and/or passer-by information. In one embodiment, the camera 44 may be constantly activated to monitor passer-by information. This type of information may be retained for analysis and communicated to the logic processing unit 9 for use in altering the advertising schema in a manner consistent with the previously description. In this way, information is obtained about passers-by not necessarily interacting with the intelligent advertising device 1. However, such information may be retained about individuals that stop to view the intelligent advertising device 1. Alternately, the camera 44 may be selectively activated to retain information about a specific user, or group of users, interacting with the intelligent advertising device 1. In other words, the camera 44 may be activated when a passer-by stops to respond to the intelligent advertising device 1. That is to say that the camera 44 may be used to retain any type of information about a person responding to the dynamic information displayed on the intelligent advertising device 1 via input means 30. In this manner, trends can be analyzed about the type of individuals, i.e. size, age, gender, socioeconomic status, etc, that respond to the prompting of the intelligent advertising device 1. For example, a local advertiser may promote a weekly special. The intelligent advertising device 1 may gather information about a specific type of individual that responds to specific advertisements. Such information may be used to alter which specials are successful and which are not.

### OBJECTS OF THE INVENTION

It is an object of the present invention to provide an electronic devices that provide improved safety features; and information features about weather, traffic, parking, and other services; a power source for charging electronic devices, such as a cell phone; and other convenience features.

It is a further object of the present invention to provide solar power to the electronic devices to provide power to make the electronic devices that are self-contained with its own power source.

It is a further object of the present invention to provide a security camera that provides information to the local police by wireless transmission.

It is a further object of the present invention to provide information about available parking spaces in the area to those who are travelling in the area and have a cell phone connected to a software application.

### SUMMARY OF THE INVENTION

The present invention discloses an electronic traffic device, including a pole or tower having mounted thereon a plurality of devices, including at least one audio speaker connected to an electronic source of information in order to provide public announcements to persons in the area of the speaker. The electronic traffic device also includes at least one security camera electronically connected to a local police station in order to provide to police video and audio surveillance of events occurring in the area of the security camera; electronic signs to provide weather information, traffic information, and parking information; a public phone that can be used by the public to call for assistance in an emergency; an alarm button connected to the local police and fire department, so that a person in the area can press the alarm and send a signal to the local police or fire department; a street lamp for providing light to the area which is connected to a power source on the traffic device, which may include either a battery pack or solar panel for providing power to the electronic devices on the pole; a charging device for cell phones and other devices for the public in the area to use; and other safety and convenience features.

### BRIEF DESCRIPTION OF THE DRAWINGS

FIG. 1 is a front perspective view of the electronic tower;

FIG. 2 is a rear perspective view of the electronic tower; and

FIG. 3 is a schematic drawing showing the power source connected to the various devices, which are mounted on the electronic traffic tower.

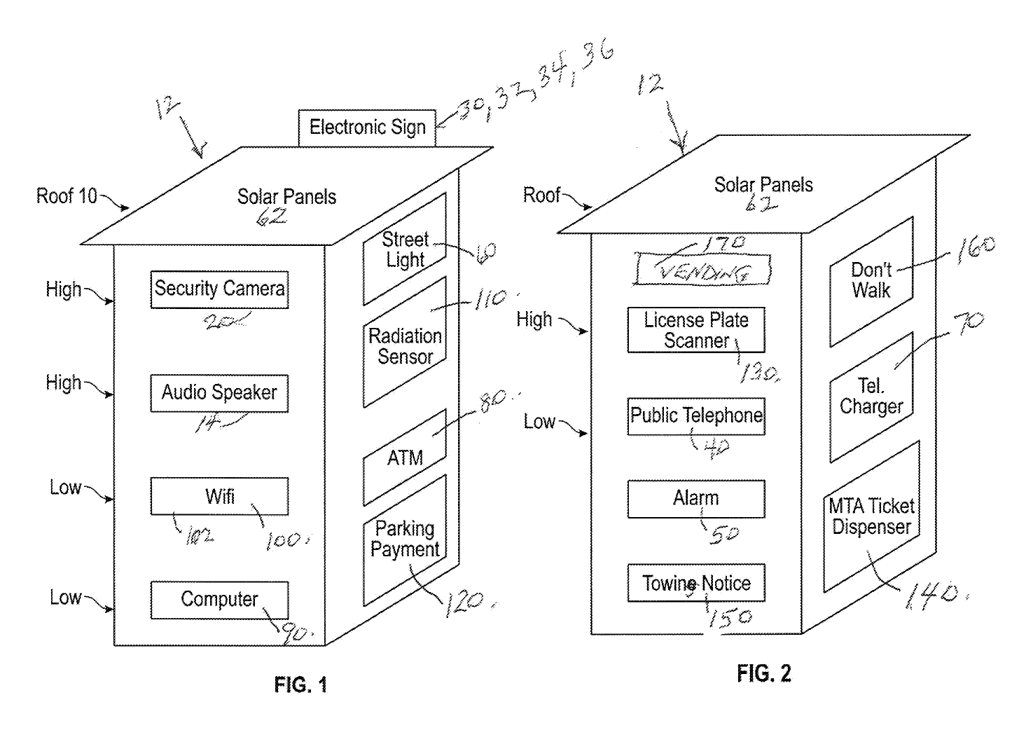

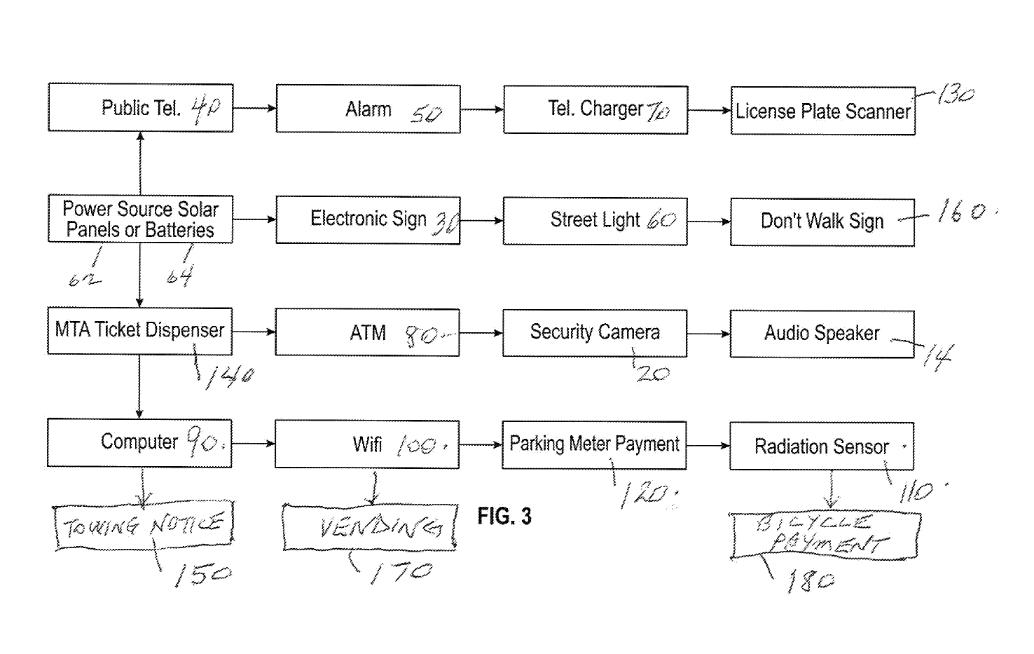

### DETAILED DESCRIPTION OF THE PREFERRED EMBODIMENT

The present invention discloses an electronic traffic device 10, including a pole or tower 12 having mounted thereon a plurality of devices, including at least one audio speaker 14 connected to an electronic source of information in order to provide public announcements to persons in the area of the speaker, including government emergency messages. The tower 12 also has mounted on it at least one security camera 20 electronically connected to a local police station in order to provide to police video and audio surveillance of events occurring in the area of the security camera. The tower 12 also has mounted on it an electronic sign 30 to provide public information about parking to persons in the area having a cell phone which includes an application for providing a source of local parking information. Additional electronic signs 32 are mounted on tower 12 to provide visually displayed advertisements (as a source of income to the city). Additional electronic signs 34 are mounted on tower 12 for visually displaying emergency government messages. Additional electronic signs 36 are mounted for electronically displaying and changing parking rules. The tower 12 also has mounted on it a public phone 40 connected to the local police that can be used by the public to call for assistance in an emergency. The public phones can also be used by potential advertisers in the public to call the city to arrange for electronic advertisements by the public.

The tower 12 also has mounted on it an alarm button 50 connected to the local police and fire department, so that a person in the area can press the alarm and send a signal to the local police or fire department. The tower 12 also has mounted on it a street lamp 60 for providing light to the area which is connected to a power source on the traffic device, which may include either a battery pack 62 or solar panel 64 for providing power to the electronic devices on the tower 12. A charging device 70 for charging cell phones and other devices for the public in the area to use is also mounted on tower 12 with the public paying a fee.

Also, an ATM machine 80 is mounted on tower 12 for disbursing funds to users in the area. Also, a computer tablet 90 is mounted on tower 12 for the public to obtain information from the computer with the public paying a fee to the city. Also, an electronic connection 102 is mounted on tower 12 for providing Wi-Fi station 100 for use by the public for a fee paid to the city. Also, a radiation sensor 110 is mounted on tower 12, and is electronically connected to the power source in tower 12, which provides the city with a warning signal as to the radiation in the area. Still further, when parking in the area, a user can pay the parking fee by having a parking payment machine 120 mounted on tower 12.

In addition, a scanner 130 is mounted on tower 12 for scanning the license plates of all vehicles parked on the street and all vehicles driving on the street. This information is supplied to the local police station for security and record keeping.

Further, a ticket dispenser 140 for dispensing and purchasing bus and train tickets is mounted on tower 12 for the public to use.

An electronic towing notice 150 is mounted on tower 12 to provide information and notice to the public as to any vehicles which have been towed, and where they are located.

Also, a “Don't Walk” electronic sign 160 is mounted on tower 12 to provide an electronic notice to the public.

A vending machine 170 is mounted on tower 12 to vend or sell products for public use.

A bicycle payment machine 180 is mounted on tower 12 to provide the public with a device for paying a fee for using a bicycle.

### OPERATION OF THE PRESENT INVENTION

The present invention discloses that cities or towns are provided with poles or towers 12, which are provided with a solar power source 62, or a power source 64 from the city or town by an electrical connection to the tower 12.

Then, the tower 12 has connected to it one of the power sources 62 or 64 in order to supply power to all of the devices mounted on tower 12. The devices include at least one audio speaker 14, at least one security camera 20, at least one electronic sign 30, at least one public phone 40, an alarm button 50, at least one street lamp 60, a charging device 70, an ATM machine 80, a computer tablet 90, a Wi-Fi station 100, a radiation sensor 110, a parking payment machine 120, a license plate scanner 130, an electronic towing notice 140, a “Don't Walk” electronic sign 150, and an MTA ticket dispenser 160.

In this manner, the invention provides safety features, informational features (electronic signs, parking information, parking payment machines, etc.), and convenience features (ATM, computer, Wi-fi, public phone, charging device, public phones, etc.).

### ADVANTAGES OF THE PRESENT INVENTION

It is an advantage of the present invention that it has provided a tower having electronic devices that provide improved safety features; and information features about weather, traffic, parking, and other services; a power source for charging electronic devices, such as a cell phone; and other convenience features.

It is another advantage of the present invention that it has provided solar power to the electronic devices that provide power to make the electronic devices that are self-contained with its own power source.

It is another advantage of the present invention that it has provided a security camera that provides information to the local police by wireless transmission.

It is another advantage of the present invention that it has provided information about available parking spaces in the area to those who are travelling in the area.

A latitude of modification, change and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

What is claimed is:

1) An electronic traffic device having a pole or tower for mounting thereon a plurality of the following devices each being connected to a power source, comprising:
a) at least one security camera mounted on said tower and electronically connected to a local police station in order to provide to police video and audio surveillance of events occurring in the area of the security camera;
b) at least one audio speaker mounted on said tower and connected to an electronic source of information in order to provide public audio announcements to persons in the area of the speaker, including emergency government voice messages;
c) electronic signs mounted on said tower for visually displaying public announcements, parking information, traffic information, weather information, and public information about museums and restaurants and attractions and events;
d) an alarm button mounted on said tower being connected to the local police and fire department, so that a person in the area can press the alarm and send a signal to the local police or fire department;
e) a public phone mounted on said tower that can be used by the public to make telephone calls for any purposes, including calls for assistance in an emergency;
f) a street lamp mounted on said tower for providing light to the area which is connected to a power source on the traffic device, including a battery pack or solar panel, for providing power to the electronic devices on said pole;
g) a charging device for cell phones and other devices mounted on said tower for the public to use;
h) a Wi-Fi station mounted on said tower for the public to use to provide a Wi-Fi connection;
i) a parking meter payment device mounted on said tower for paying a parking toll;
j) a computer tablet mounted on said tower for the public to use to obtain information from the computer; and
k) a roof mounted on said tower to protect the public from inclement weather while using said devices mounted on said tower.

2) An electronic device in accordance with claim 1, further including an ATM machine mounted on said tower for disbursing funds to users.

3) An electronic device in accordance with claim 1, further including a radiation sensor mounted on said tower and electronically connected to the power source in said tower to provide a warning signal as to the radiation in the area.

4) An electronic device in accordance with claim 1, further including a license plate scanner mounted on said tower and electronically connected to the power source in said tower to provide a scanner for license plates.

5) An electronic device in accordance with claim 1, further including an electronic towing sign mounted on said tower to provide notice to the public as to cars which have been towed.

6) An electronic device in accordance with claim 1, further including an electronic ticket dispenser mounted on said tower to dispense tickets to the public for buses and trains.

7) An electronic device in accordance with claim 1, further including a vending machine mounted on said tower;

8) An electronic device in accordance with claim 1, further including a bicycle payment device mounted on said tower for paying for use of bicycles;

9) An electronic device in accordance with claim 1, further including electronic traffic signs stating not to enter or one way street;

10) An electronic traffic device having a pole or tower for mounting thereon a plurality of the following devices each being connected to a power source, comprising:
a) at least one security camera mounted on said tower and electronically connected to a local police station in order to provide to police video and audio surveillance of events occurring in the area of the security camera;
b) electronic signs mounted on said tower for visually displaying public announcements, parking information, traffic information, weather information, and public information about museums and restaurants and attractions and events;
c) an alarm button mounted on said tower being connected to the local police and fire department, so that a person in the area can press the alarm and send a signal to the local police or fire department;
d) a public phone mounted on said tower that can be used by the public to make telephone calls for any purposes, including calls for assistance in an emergency;
e) a street lamp mounted on said tower for providing light to the area which is connected to a power source on the traffic device, including a battery pack or solar panel, for providing power to the electronic devices on said pole;
f) a charging device for cell phones and other devices mounted on said tower for the public to use;
g) a Wi-Fi station mounted on said tower for the public to use to provide a Wi-Fi connection;
h) a parking meter payment device mounted on said tower for paying a parking toll; and
i) a roof mounted on said tower to protect the public from inclement weather while using said devices mounted on said tower.
